(19) United States
(12) Patent Application Publication
(10) Pub. No.: US 2015/0170448 A1
(43) Pub. Date: Jun. 18, 2015

(54) ENTRY LOCK CONTROL AND OPERATION SYSTEM

(71) Applicant: FINGI INC., New York, NY (US)

(72) Inventors: Jacob Morris Robfogel, New York, NY (US); Robinus Van Den Ijssel, New York, NY (US); Eran Sherin, New York, NY (US); Bradley Perkins, New York, NY (US)

(21) Appl. No.: 14/411,900

(22) PCT Filed: Mar. 15, 2013
(86) PCT No.: PCT/US13/32701

§ 371 Date: Dec. 29, 2014

Related U.S. Application Data
(60) Provisional application No. 61/668,987, filed on Jul. 6, 2012.

(51) Int. Cl. G07C 9/00

(52) U.S. Cl. CPC G07C 9/00174; G07C 9/00007

(57) ABSTRACT

A system for hotel and residential properties to allow guests and residents security access using electronic devices already in the possession of the user. The system would allow hotel and residential properties to provide guests and residents with an inexpensive near field communication (NFC) tag to affix to their mobile device. Such an NFC tag could be registered by the hotel front desk upon check-in, or at the first reader the guest encounters at the hotel, in conjunction with their mobile device. Additionally, the system allows for the use of peer-to-peer (P2P) NFC to create a secure connection and allow data transfer between a NFC enabled door lock and a mobile device, allowing for an encrypted door code to be used.

### FIELD OF THE INVENTION

The present invention relates to systems, methods and mobile devices that allow a hotel guest to interface with the hotel to access secured areas such guest rooms, elevators and other facilities, using an electronic identification system.

### BACKGROUND OF THE INVENTION

Hotel security for guest, and security for residents in multiple residence properties, has included keys to keycards. When a guest checks into a hotel property, they are given a key or keycard to access their room, and possibly elevators, and other facilities such as the pool or gym. In the case of the keycard, the magnetic strip on the card is written by the hotel's front desk to include the guest's room, and check-in and check-out dates. Additionally, the key may include other information about the guest, including other access privileges.

The present keycard system has several disadvantages. The guest must check-in at the front desk upon arrival to be issued their keycard. The front desk must spend time and effort to program keycards for each guest. While not significantly expensive, the hotel must spend efforts to retrieve and reuse keycards after a guest's visit. While most guests will spend some effort to return the keycard to the front desk, some keep or toss their keycard.

In recent years, the magnetic strip keycard has been replaced with radio frequency identification (RFID) keycards. These cards have the advantage of not needing to be inserted or swiped through a reader, like magnetic strip keycards. However, they are more expensive to replace if lost. Additionally, RFID keycards can have security issues, as they can be read by any reader they pass near, which can be as far away as 10 to 20 feet. This may allow unintended reads of the keycard, which may be used to copy the keycard.

Partially in response to the security issues of RFIDs use for secure access, near field communication (NFC) was developed. NFC works only in the range of a few inches. NFC is a set of standards for smartphones, and other mobile devices, such as tablet computers and MP3 players, to establish radio communication with each other by bringing them into close proximity. Not only can NFC active devices communicate with each other, communication is also possible between an NFC device and an unpowered NFC chip, called an NFC tag. The standards for NFC devices and NFC tags include ISO/IEC 18092, and standards promulgated by the NFC Forum, which was founded in 2004 by Nokia, Philips and Sony, and has more than 160 members. The forum also promotes NFC and certifies device compliance.

One limitation of the NFC chipsets installed in many mobile devices is that applications on the mobile device may not be allowed to access the secure encryption routines built into the NFC chipsets. This limitation means that the applications which are not specifically granted access by the mobile device manufacturer to the secure NFC elements are unable to make secure NFC connections.

A long-time goal of the hospitality industry has been a way for guests to bypass the front desk and go directly to their assigned room at check-in. Hotels have longed for a system like the car rental preferred customer systems, where a customer can go directly from the shuttle to a display board showing the stall their car is waiting in, and drive away without having to visit rental counter. The bottleneck for hotels has been how to get the guest a key or keycard without visiting the front desk.

In the vacation rental market, there is a similar problem with rentals where there is no onsite staff available to greet the renter. Keys are sometimes left under the mat, or with a neighbor. In both cases, there is a need for a system which uses a device already in the possession of the prospective guest or renter, which can be programmed remotely with guest information, and which maintains the security of keys or keycards.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to provide a method to allow the secure creation, use and removal for security access of hotel and residential properties using a user's preexisting mobile device.

It is also an object of the present invention to allow hotels and other residential properties to automatically program and control security access devices using computer systems already containing guest and resident information.

It is also an object of the present invention to allow hotels and other residential properties to have a path to implement electronic security using NFC enabled mobile devices and NFC tags.

It is also an object of the present invention to allow peer-to-peer (P2P) NFC to be used to create a secure connection between mobile device and door lock without the use of the existing proprietary secure NFC functions of the NFC chipsets in many mobile devices.

### SUMMARY OF THE INVENTION

The present invention provides a system for hotel and residential properties to allow guests and residents security access using electronic devices, such as a smartphone or tablet computer, already in the possession of the user.

Alternatively, the present invention would allow hotel and residential properties to provide guests and residents with an inexpensive NFC tag to affix to their mobile device, such as a smartphone or tablet computer. Such an NFC tag could be registered by the hotel front desk upon check-in, or at the first reader the guest encounters at the hotel, in conjunction with their mobile device.

The present invention may also, in some embodiments, allow for the use of P2P NFC to create a secure connection and allow data transfer between a NFC enabled door lock and a mobile device, allowing for an encrypted door code to be used and also for any data transferred from the door lock to be passed along to the mobile device, which can then use a mobile network connection to transfer the data to a hotel server. This function allows a door lock to communicate with the hotels servers without having to be equipped with a network connection of its own.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of a mobile device according to one embodiment of the invention.

FIG. 2 is a schematic diagram of a system for providing services to a hotel guest on a mobile device according to one embodiment of the invention.

FIGS. 3A-3C are schematic diagrams of exemplary user interfaces for providing services to the hotel guest on a mobile device according to one embodiment of the invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this detailed description section.

It will be apparent to those of ordinary skill in the art that although the systems and methods of this invention are often embodied in this description as applying to hotels, hotel rooms, and hotel guests, that the same systems and methods can be applied to other fields as well, and that the use in this document of these terms is used for simplicity rather than as a limitation of the scope of the invention. For instance the guest communication center herein described is an invention not just for hotels but for any facility, such as homes, condominiums, apartment complexes, cruise ships, office buildings or other structures or businesses. Likewise, all of the devices, methods, and systems herein described can be used for any of these businesses and locations as well. Therefore the terms hotel, hotel room, and guest should not be read as limiting the scope of this invention to the hospitality industry.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” “electronic device” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Near Field Communications (NFC) link, Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, Wi-Fi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

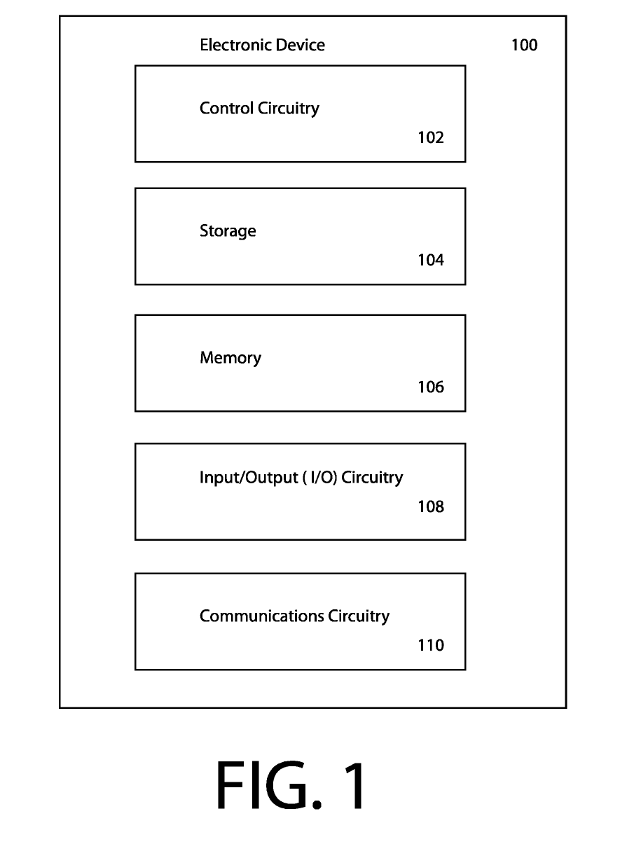

FIG. 1 is a schematic view of an illustrative electronic device for providing an application operative to interface with a hotel system in accordance with some embodiments of the invention. Electronic device 100 can include control circuitry 102, storage 104, memory 106, I/O circuitry 108, and communications circuitry 110. In some embodiments, one or more of the components of electronic device 100 can be combined or omitted. In some embodiments, electronic device 100 can include other components not combined or included in those shown in FIG. 1 (e.g., motion detection components, a power supply such as a battery or kinetics, a display, a bus, a positioning system. or an input mechanism), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer or a docking station.

Control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface.

Storage 104 can include, for example. one or more storage mediums including a hard-drive, solid state drive, flash memory, permanent memory such as ROM. any other suitable type of storage component, or any combination thereof. Storage 104 can store, for example, media data (e.g., music and video files), application data (e.g., for implementing functions on electronic device 100), firmware, user preference information data (e.g., media playback preferences), authentication information (e.g. libraries of data associated with authorized users), lifestyle information data (e.g., food preferences. exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof

Memory 106 can include cache memory, semi-permanent memory such as RAM and/or one or more different types of memory used for temporally storing data. In some embodiments, memory 106 can also be used for storing data used to operate electronic device applications, or any other type of data that can be stored in storage 104. In some embodiments, memory 106 and storage 104 can be combined as a single storage medium.

I/O Circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive or resistive sensing mechanic, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, L4 GHz, and 5.6 GHz communication systems), infrared, GSM, GSM plus EDGE, CDMA, quadband, and other cellular protocols, VOW, Near Field Communications (NFC), or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one or more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled to a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

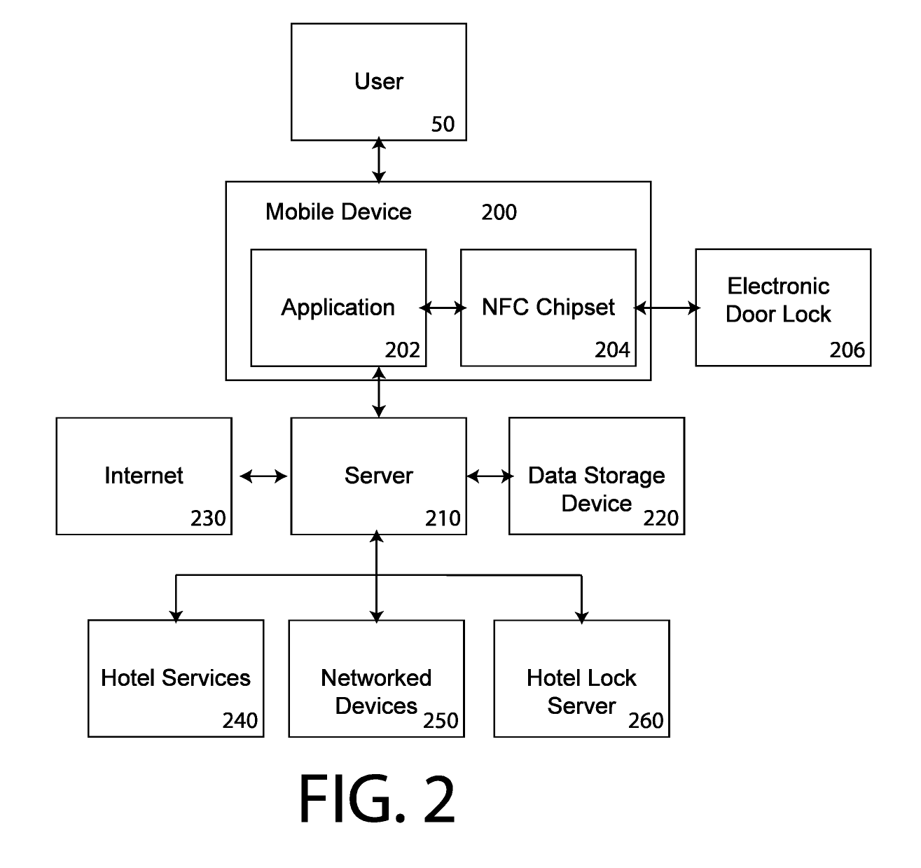

FIG. 2 illustrates a system for hotel and residential properties to allow guests and residents security access using a mobile device 200, which is a mobile version of electronic device 100, described above, such as a smartphone or tablet computer. In some embodiments, the mobile device 200 will be provided by the guest or user 50, such as a previously-owned smartphone or tablet. In other embodiments, the mobile device 200 may be provided by the hotel to the guests. Alternative, the present invention would allow hotel and residential properties to provide guests and residents with an inexpensive passive NFC tag (not shown in FIG. 2.) to affix to their mobile device, such as a smartphone or tablet computer. Such an NFC tag could be registered by the hotel front desk upon check-in, or at the first reader the guest encounters at the hotel, in conjunction with their mobile device.

In one embodiment, the system combines the use of a central reservations engine server 210 and use of a built-in NFC Chipset 204 in mobile device handsets (e.g., cellular telephones) to be able to use the phone as a room key. The system provides a link between the hotel's Property Management System (PMS) and the handheld device to be able to securely transmit the hotel room and key information software installed on the mobile device. This allows guests to use their own phone equipped with NFC Chipset 204 or a mobile device 200 provided by the hotel to act as the room key. This allows hotels to do a pre-arrival check-in and allows hotel guests to receive room and key information on their own phone and go straight to their room.

An advantage of the system include that it provides all of the advanced services that hotels are looking to provide through a convenient mobile device 200 either provided by the hotel or with an application 202 installed on a user owned mobile device. Another advantage is that it allows hotels to provide advanced new technological, communication and entertainment options using existing infrastructure.

In embodiments where the application 202 is installed on the user 50's own phone, the application 202 allows guests to use their mobile device 200 across multiple hotels. The application 202 installed on a guest's own mobile device 200 may be advantageous because: guests can personalize the interface, guests will experience an improved/enhanced and consistent experience across properties, and guests will have access to optional travel-based features that don't require a hotel stay.

Different hotels may have a different set of features turned on so the GUI can be modular. Hotels can pick, choose and configure functionality available to their guests based at least in part on the service offerings of the different hotels, which may have multiple variances. These variations will be reflected in the version of the application 202 used on a particular property.

The mobile device 200 and/or interface application 202 may be personalized. In addition, at the user 50's discretion, the system may provide customization automatically based on behavior and content choices.

In one embodiment, the mobile device 200 serves as a key to the room. The mobile device 200 may serve as room key via NFC chipset 204. The device receives the encrypted key via Wi-Fi, 3G/EDGE/GPRS, Bluetooth, or docking station from Hotel and optionally configures a user 50's Personal Identification Number (PIN). The guest has option to enter the PIN and hold the mobile device 200 up to the electronic lock 206 to unlock it. Alternative possibility is to have the NFC chipset 204 in the mobile device 200 write to an RFID sticker mounted in the phone, or use an authorized Secure Element in the phone i.e. built-in SE or embedded on a SIM card provided by a Telephony provider. The mobile device 200 may interface with key lock system to use built in Phone NFC features to be able to interact with door locks. In one embodiment, the mobile device 200 receives key codes from hotel server 210 based on HTNG standards.

In some embodiments, users 50 can create an account and customize their settings and preferences so that they will be automatically applied at any hotel where the mobile device 200 is provided.

In one embodiment, the system includes a mobile device 200 (Dedicated or Application 202 on 3rd Party Device), a Control Device, a 3G SIP SERVER, a Central Server, and a Bandwidth Optimization Server (HSIA/Firewall/Logging).

In one embodiment of the present invention, a mobile device 200, such as a smartphone, tablet computer, laptop computer or other handheld device runs an application 202, or application 202, which is operably connected to a server 210, which might be located on the hotel property, or may be virtually located in an internet cloud 230. The hotel server 210, in combination with a guest mobile device 200 and/or NFC tag, provides and a unique NFC based key management system for hospitality and other markets.

One embodiment of the present invention uses a unique technology that enables smartphones to control many aspects of a room including the TV, phone, lights and environmental controls, as well as to be able to present hotel services and interact in a bidirectional manner with hotel PMS systems. The hotel server 210 runs a NFC tag management system that can associate a unique NFC tag UID with a specific guest and reservation. Hotel lock vendors supply hardware and software that provides network enabled locks that can work with the hotel server 210 of the present invention to provide a way for hotel and other hospitality guests to transmit and receive information via an enabled smartphone, tab or other device that will allow for the guest's own device to be able to securely receive key information to be able to access the property, elevators, enter the room with no need for the guest to receive a key at the front desk, or even to make payment for goods and services through a connection with the hotels PMS system.

The present invention allows the hotel server 210 and guest mobile device 200 running a hotel application 202 combination, working with electronic supplies to tap into the approximately 60,000 to 80,000 network updatable third generation RFID locks currently deployed and additional 5,000,000 locks requiring a basic and easy to implement hardware and software upgrade for an existing electronic lock originally using a magnetic strip or other electronic means.

In one embodiment of the present invention, an interim solution while waiting for NFC to be deployed in more smartphones, (anticipated to become a standard feature in smartphones by 2014-2015), uses hotel provided (and possibly branded) NFC tags that can be easily placed on or in a smart phone to provide the functionality needed when combined with network enabled locks (preferably, such as those from VingCard or OpenWays) to be able to provide a full automated pre-check-in process whereby a guest can receive room assignment and have the lock set to accept the specific NFC tag with the guest's mobile device, such as a phone. In some embodiments of this system, not all of the electronic locks will need network enabled, as long as the guest accesses at least one network enabled lock first. In this type of system, upon accessing the first network enabled lock, that lock will be able to load onto the NFC card the access codes for any other electronic non-networked locks the guest will have access to.

The following is the process of one embodiment of the present invention. Hotel creates database of UID and simple tag names (STN) on the hotel server 210. Guest downloads hotel application 202 to any Wi-Fi enabled smartphone (Apple iOS version 4 and up, and Google Android version 2.2 and up). The hotel NFC tags are distributed to guests that have downloaded the hotel application 202 by hotel staff by mail before check-in or at check-in. Hotel staff enters guest's first name, last name, e-mail, loyalty membership number info into admin portal in hotel server 210 backend management portal. Guest name, phone IMEI, and Wi-Fi MAC are associated with UID in the hotel server 210 database. The hotel checks-in the guest. The hotel server 210 receives a message from the hotel's property management system (PMS) that the guest has checked-in, and searches to see if name matches any existing key tag UID in the hotel server 210 database.

If there is no existing key tag UID in the hotel server 210 database, then the hotel server 210 sends a message to front desk staff to prompt to prepare a NFC tag, and pass along information to hotel key lock server 260 with standard check-in information. Upon arrival at the hotel, guest is given the NFC tag. If there is an existing key tag UID in hotel server 210 database, then the hotel server 210 sends a message to the hotel lock server 260 with specific UID of the NFC tag.

If the hotel is using network enabled electronic locks 206, the hotel lock server 260 updates hotel NFC lock 206 with UID information and check-out date. However, if hotel is using non-network enabled locks, the NFC tag is updated with lock information to be able to unlock the door. It is possible to update the NFC tag using a single network enabled lock placed at the entrance, or in the elevators, as long as it is a reader/writer that all guests must pass before going to the room. If the hotel is using network enabled locks, user 50 can extend check-out time via phone and lock will be updated automatically.

If the hotel is using network enabled electronic locks 206, upon check-out, UID will become unable to unlock room or access elevator based on time frame set by hotel. If using non-network enabled locks, lock will no longer accept UID at specified check-out time at key creation. The advantage of this embodiment is that it can be presently implemented in most hotels. Additionally, it provides hotels a strong incentive to upgrade to network enabled locks (such as those supplied by VingCard and Zigbee). Alternatively, non network locks may be instructed to automatically invalidate earlier NFC codes from earlier key cars upon the first use of a new key code, enabling all previous cards to be automatically cancelled upon the arrival of a new guest.

Another embodiment of the present invention uses peer-to-peer NFC (P2PNFC) protocol. Using P2PNFC allows network enabled electronic locks 206 to talk with NFC enabled mobile devices 200, such as smartphones, using a protocol that does not demand constant ownership and control of the NFC smart element on the device. The hotel guest downloads the hotel application 202 on and NFC enabled device, such as Samsung's Galaxy S III, Google Nexus S/Galaxy Nexus S, or any future NFC enabled mobile device 200 that supports P2P NFC mode. The hotel server 210 registers guest name and phone ID (phone number and IMEI) linked together in the hotel server 210 database. The guest arrives at the destination location and notifies the hotel server 210 of arrival, which might be at the hotel, airport or other location. This could be done by the guest, through the hotel application 202. However, this could be done by the hotel application 202 noting that the guest has appeared on the local area network of the hotel or airport, or could be done by the hotel application 202 using the GPS positioning system in the mobile device. Please note that IMEI standard is used here and elsewhere in this description, but the invention envisions the use of any other unique identifier to provide the same function, such as MAC address, Wifi adapter ID, or the like.

In some embodiments, upon receiving arrival information, the hotel server 210 notifies the hotel to process the check-in, either automatically within the hotel server 210, or manually by the hotel staff. In either case, the property management system (PMS) checks-in the guest. The hotel server 210 then receives the check-in message from the PMS. The hotel server 210 sends command to hotel lock server 260, which includes at least the guest's room number, check-in date and time, and check-out date and time. In response, the hotel lock server 260 replies with an encrypted key code to the hotel server 210 to write a NFC key. This encrypted key code is stored by the hotel server 210 in a secure database. The hotel server 210 then sends a message to the guest, stating the room number, and confirming the check-in, but not sending key. When the guest encounters the first hotel networked-enabled lock, either at access door to property, in elevator, or at their room door, and presses a key icon on hotel application 202, the hotel application 202 activates a P2PNFC signal to the hotel networked enabled lock.

However, if the hotel application 202 is a foreground active application 202, then when it detects a P2PNFC signal from a hotel networked enabled lock, the hotel application 202 may activate P2PNFC signal, obviating the need for a guest key press in the hotel application 202. The hotel application 202 checks the mobile device 200 (i.e. smartphone) to see if a valid key is already stored.

However, it is not necessary to store the NFC key information in the guest's mobile device, as the hotel application 202 can request a new NFC key every time over the secure connection to the hotel server 210, or even request the NFC key information directly again from the hotel lock server 260. For instance, if first the hotel networked enabled lock encountered by the guest's mobile device 200 is in the elevator, the hotel server 210 may send the NFC key to the mobile device 200 upon detecting hotel Wi-Fi, or the hotel will ensure a Wi-Fi/3G connection in elevator.

The P2PNFC signal interacts with hotel network enabled lock, and if the NFC key code is valid, the lock will open. Because the mobile device 200 may, in some configurations, not know if lock has been successfully opened or not, the hotel networked enabled lock 206 may send a signal status of success or failure back to hotel application 202 via P2PNFC.

The electronic lock 206 can also send other information through P2PNFC to the mobile device 200, for instance it could send the last ten entries in its information log and/or the battery status of the electronic lock 206 and any other data which the property wishes to collect. In some embodiments the application can send this data to the hotel server by means of the mobile device's 200 network connection. This P2PNFC connection from a hotel non-networked enabled lock 206 to the hotel application 202, back to the hotel server 210, adds hotel non-networked enabled lock functionality which is similar to the functionality of network enabled locks. This method has the advantage of allowing hotels to integrate the functionality of this invention without having run a network connection to each of the electronic locks 206.

In any event, whether the hotel is networked enable or non-networked enabled, events from the hotel application 202 can be transmitted back to the hotel server 210 for storage, and/or synced to the hotel lock server 260.

In another embodiment of the present invention uses a SIM card server, managed globally or by a local telecommunications company (such as software developed by Assa Abloy Mobile Keys), is integrated with the hotel application 202 and hotel server 210 to allow authentication through a SIM card in the mobile device 200 (i.e. smartphone), where a secure element on the SIM to talk to the NFC. In this embodiment, the guest downloads the hotel application 202 to a NFC enabled mobile device 200 (such as Samsung Galaxy S3, Google Nexus S, or Galaxy Nexus S, or any future NFC enabled phone).

The hotel server 210 registers the guest name and phone ID, comprising the phone number and IMEI, linked together in hotel server 210 database. The hotel guest arrives at the hotel location (or other location, such as the local airport) and notifies the hotel server 210 of arrival using the hotel application 202. Hotel server 210 notifies the hotel to process the check-in, which could be automatically within the hotel server 210, or could be a manual process to be done by the hotel staff. In either situation, the hotel PMS checks-in the guest. The hotel server 210 receives the checked-in message from the hotel PMS. The hotel server 210 sends a command to hotel lock server 260 (including room number, check-in date and time, and check-out date and time) and requests encrypted key code be sent to a SIM card server 210 managed globally or by the local telecommunication company. In the case of a global SIM card server 210, the SIM card server 210 communicates with the local telecommunications partner to transmit the encrypted key code to the mobile phone SIM with a secure element inside. The secure element will then be able access the hotel networked enabled lock to unlock the guest's door. The hotel networked enabled lock sends a signal status of either success or failure back to the hotel application 202 via NFC, as well as hotel networked enabled lock battery status, and any other messages, so that they can be logged for maintenance.

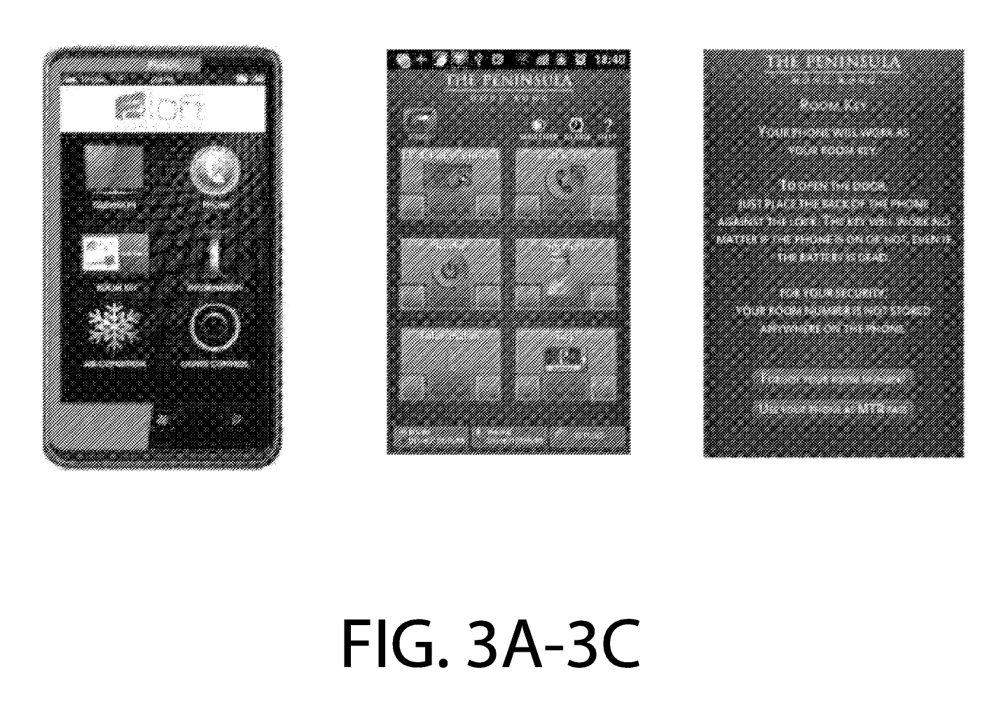

FIG. 3A-3C are schematic diagrams of exemplary user interfaces for providing services to the hotel guest on a mobile device according to one embodiment of the invention.

It will be understood that the invention disclosed herein could be used for any secure access system, including physical access such as doors, elevators, etc. in any building, whether a hotel, residential building, an office building, or any facility. Additionally, the invention could be used for secure access to non-physical items, such as information, It will also be understood that the various servers disclosed herein may reside on separate computing devices, but may, in any combination, be on single or multiple devices, or on a virtual cloud-based server.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

1. A method of providing a user with secure access to an electronic lock using a mobile device comprising the steps of:
identifying the user;
assigning the user a unique security identifier; and
providing the unique security identifier to the mobile device; and
providing the unique security identifier to the electronic lock via connection with the mobile device so as to provide user access.

2. The method of claim 1, wherein the step of identifying the user comprises the steps of:
determining the location of the user; and
retrieving user identification information stored in a database.

3. The method of claim 2, wherein the step of assigning the user a unique security identifier comprises using the user identification information to generate the unique security identifier.

4. The method of claim 1, wherein the unique security identifier is a NFC key code.

5. The method of claim 1, wherein the electronic lock is a NFC enabled lock.

6. The method of claim 1, wherein the electronic lock is a NFC networked enabled lock.

7. The method of claim 1, wherein the mobile device is a smartphone.

8. The method of claim 1, wherein the mobile device is a NFC enabled smartphone.

9. A system providing a user with secure access to an electronic lock using P2PNFC on a mobile device comprising:
a mobile device;
an NFC chipset connected to the mobile device;
an application on the mobile device providing P2P functionality to the NFC chipset; and
electronic lock capable of P2P which is in range of NFC connectivity of the NFC chipset.

10. The system of claim 9, wherein the mobile device is a smartphone.

11. A method of providing a user with secure access to an electronic lock using P2PNFC on a mobile device comprising the steps of:
receiving user information from a server via network connectivity;
connecting to a P2PNFC enabled electronic door lock via P2PNFC connection;
receiving electronic door lock information via P2PNFC connection.

12. The method of claim 11, wherein the user information is an NFC key code.

13. The method of claim 11, wherein the electronic door lock information is one or more of the following:
battery status;
data from previous NFC connections; and
maintenance information;

14. The method of claim 11, comprising the additional step of:
sending data received from the electronic door lock to a server via network connectivity.
